(19) United States
(12) Patent Application Publication
(10) Pub. No.: US 2004/0114797 A1
(43) Pub. Date: Jun. 17, 2004

(54) Method for automatic determination of color-density correction values for the reproduction of digital image data

(76) Inventor: Guenter Meckes, Munich (DE)

Correspondence Address: Karl F. Milde, Jr., Esq., MILDE & HOFFBERG, LLP, Suite 460, 10 Bank Street, White Plains, NY, 10606, US

(21) Appl. No.: 10/691,107

(22) Filed: Oct. 22, 2003

(30) Foreign Application Priority Data
Dec. 16, 2002 (EP) 02028230.7

(51) Int. Cl. G06K 9/00

(52) U.S. Cl. 382/167

(57) ABSTRACT

A method for automatic determination of color-density correction values for the reproduction of digital image data, wherein image color-density values of the digital image data are determined at least by area, and are compared with corresponding, known reproduction color-density values. For better results, eye scleras are identified within the image data, and image color-density values are determined from them.

### BACKGROUND OF THE INVENTION

The invention relates to a method for automatic determination of color-density correction values for the reproduction of digital image data in a photographic printer.

It has been necessary during conventional photographic printing procedures, where the images from photographic film are projected onto photographic paper, to determine the exact exposure time for the basic colors red, green, and blue of each image to be printed so that the image can be reproduced so realistically that it always has the same appearance regardless of the printing device. For this, an appearance of the image is sought that creates as closely as possible the impression of what the photographer had in mind when he captured the image. Thus, for example, distribution of basic colors in the reproduction should be such that gray subjects in the printed photograph actually look gray, but relevant color tones such as skin tones receive realistic coloration.

The published German Patent Application No. DE-OS 19 14 360 describes a procedure for determining exposure times and intensities during printing of photographic film images onto light-sensitive material in such manner that gray subjects in the print have a non-colored gray reproduction. It teaches that all images on a photographic film be sampled and that their image content be taken into account when exposure times and intensities are to be determined for an image. This procedure has proven to be very advantageous if the entire film includes a specific color cast or a missing color specified by constant exposure relationships. If, on the other hand, individual images are tinted differently, which often occurs, for example, when photographs are taken under artificial lighting, this procedure cannot be used. Nowadays, more and more images are captured using digital cameras, scanners, or other digital equipment, whereby images from a series are not always presented together in an order. Thus, individual images for which this recommended procedure is not applicable occur with increasing frequency.

The German Patent No. DE-PS 42 30 842 also describes a procedure for determining exposure light quantities during the printing of photographic film images on photographic paper. In this procedure, the image content of individual images is used. Various criteria are checked in order to be able to identify skin areas located in the image content unambiguously. Colors of skin tones are assigned to the skin areas so identified, and the tones are compared with the photographed colors of these areas. Thus, correction values result for the colors of the entire image which intend primarily to reproduce these areas of skin area realistically. The problem with such image-processing procedures is that skin tones need not always appear the same. For example, skin tones of Africans and Asians look different from those of Central Europeans.

### SUMMARY OF THE INVENTION

Thus a principal object of the present invention is to develop a method for the automatic determination of color-density correction values for the reproduction of digital image data that allows more reliable determination of these values than do the known methods.

This object, as well as other objects which will become apparent from the discussion as follows, are achieved, in accordance with the present invention, by identifying eye scleras within the image data and determining image color density values based on these scleras.

According to the invention, scleras of the eyes within the image data to be reproduced are identified and used to determine color-density correction values. It is known that eye scleras are essentially white in most persons, or occasionally slightly red. Thus, as soon as a sclera is identified within the image data, color-density correction values for the reproduction of the image may be so selected that this image area is transferred from the color it possesses in the image into an essentially white color tone during reproduction. The color-density correction values necessary for this may also be applied to all other areas of the image as well as to the sclera, since it may be assumed that a color cast that distorts the color of the sclera in the image will distort all other digital image data with a color cast. As soon as a sclera is identified in the image data, its actual color-density values—i.e., the image color-density values—are determined, and are compared with the reproduction color-density values—i.e., with the values that a sclera should have in an ideal reproduction, or generally possesses in nature. The color-density correction values resulting from this comparison are used to correct all image data to be reproduced from this image, or from all images of a photography session. This procedure is basically realized in the same manner as the use of skin tones or of skin-tone image areas, but it has the decisive advantage that scleras of almost all persons are the same color, i.e., the same white tone. Use of eye sclera colors to determine color-density correction values is also especially advantageous because, as soon as the essentially white sclera is correctly reproduced in the image, it may be assumed that all other white subjects in the image data will appear white after this color-density correction. Realistic reproduction of white image areas creates a bright, brilliant impression in the observer of the reproduced image. Thus, significant improvement of the reproduced colors is achieved in comparison to conventional correction procedures because of gray values in skin tones.

Face-detection procedures may be used particularly advantageously to identify eye scleras. In this, the image data in general are first examined for contiguous skin-tone areas. The image areas thus identified are subsequently checked regarding plausibility whether a face is actually involved in the located areas. For this, the geometry of the found area, or distinctive facial density points of potential eyes, mouth and nose etc., is checked. Such procedures are state of the art. An example of this is disclosed in “Face Detection from Color Negative Film Using Flexible Template”, IS & T/SID Eight Color Imaging Conference, p. 140 ff. In some of these face-detection procedures, the identification of a face automatically produces the position of the eyes located within it. After the recognition of a face when using other face-detection procedures, it is necessary to locate the eyes. For example, dark areas within the face that are located within specific, known proportion ratios with respect to one another, and with respect to the shape and edges of the face, may be identified. Two of these denser points to be sought according to known geometric considerations will thus represent the eye positions.

Further especially advantageous procedures used to determine eye positions for the identification of scleras are known from the realm of so-called “red-eye” recognition. These image defects, the so-called red eyes, which are produced very frequently when digital cameras are used, are often detected and corrected during image processing. As soon as red-eye is detected and corrected as necessary, the location in the image where eyes have been identified is known. These so-called eye positions may be used to identify a sclera. An example for such a procedure is disclosed in the European Patent No. EP 09 61 225 A2.

Within the scope of this procedure, all other methods to determine eye positions may be used. Thus, the eye, for example, may also be identified using the overlay of so-called eye templates, or eye models, as is described, for example, in the U.S. Pat. No. 6,151,403.

As soon as the positions of the eyes are known, image points that belong to scleras within the image data corresponding to these eye positions may be sought. A particularly advantageous procedure to identify image points that belong to scleras consists of searching for areas of approximately white color in the reproduction data set in the areas where eyes are normally positioned. For this, one may seek areas with high luminance and low color saturation.

As soon as image areas near eye positions are identified as potential components of scleras, it should advantageously be verified that these sclera candidates are actually scleras rather than white areas, such as reflected light, white eyeglass frames, etc. Such reflected light may occur as white areas in the image, thus creating areas of low density. Verification is advantageously performed by investigating the region of potential sclera components, whereby known image content lying adjacent to the scleras is sought. Thus, the colors and densities found in the vicinity of the areas identified as scleras are checked to see if it is plausible that an iris or eyelashes or the like is at these locations.

During the search for areas that represent image data of scleras, one may, as mentioned above, often encounter confusion with reflected light, since such reflected light also possesses a white color just like scleras. This particularly occurs in the eyes or as a reflection from eyeglass frames or lenses, and also in skin areas. This reflected light often involves areas in which at least one color is saturated. Therefore, an option to distinguish between scleras and reflected light is provided in that the color saturation of each color is investigated, and a sclera is identified only when none of the colors is saturated.

Geometric characteristics of the identified areas may also be used in order to distinguish between reflected light and scleras. Thus, reflected light is generally small, narrow, and extended, while the sclera area in the image represents a larger, more compact object.

In an advantageous embodiment of the procedure, the image points identified as sclera points, which lie in the vicinity of eye positions and possess corresponding density profiles, are compiled into a contiguous area. At least a portion of the sclera must lie within this contiguous area. This may also be used to verify the identified sclera. In particular, there is a large amount of image data available in such a contiguous area, which may be analyzed as belonging to a sclera. More accurate color-density correction values may thus be derived from this larger amount of image data than from a few, individual points.

It is thus advantageous, for example, to determine a median sclera color-density value for the image from all color-density values of a sclera area. Of course, it is also possible to use individual points for the determination of color-density values of the current sclera. However, pure white points are not used, but rather lightly tinted points that may occur in any sclera, thus distorting the result. It is therefore more reliable to work with values that result from the overview of many sclera points, or of the entire area identified as sclera.

This actual image color-density value of the sclera extracted from the image to be reproduced must now be transformed into a color-density value that ensures an optimal impression upon reproduction. Such an optimally-suited reproduction color-density value is preferably determined in advance, and is made available in a buffer to the image-processing procedure. To determine this value, either statistics of fictional optimally-reproduced scleras may be performed, or images that reproduce scleras well may be scanned and an average of their color-density values may be established. It is also possible to configure the procedure to be self-learning, whereby a supposedly optimal reproduction color-density value is selected that checks the image and corrects it as necessary. This procedure is repeated until an optimal image impression of the sclera is determined. The value thus obtained is kept as the future reproduction color-density value. It has been shown that, under certain circumstances, it is advantageous to allow an impression, with essentially white or possibly a light red tint, to be created by means of suitable selection of color-density values.

The color-density correction values obtained from the sclera may now be applied to the entire image to be reproduced. Since these correction values were obtained from essentially white image information, it may be assumed that white subjects appear correctly in the reproduction because of this correction. A further advantageous approach consists of calculating correction values such as those for gray-scale values or skin tones, using the color-density correction values obtained from the scleras with those obtained from other known methods to determine color-density correction values in order to obtain a compromise in the image that reproduces all possible subjects as well as possible based on average color-density values. Using this approach, weighting factors may be added to the color-density correction values obtained from various methods so that an overall color-density correction value results for each color.

An additional advantageous method that is slightly more expensive, but which allows for the optimal use of the color-density correction values most suited for each image, consists of determining the color-density correction values that are obtained using various methods in dependence upon the image subject. Thus, it is advantageous in images containing many white areas to weight the color-density correction value obtained from the scleras more strongly than those from other color-density correction values. Color-density correction values obtained from skin tones should be preferred for images containing many skin areas. Any combination of various color-density correction values may thus be derived.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a flow chart of a preferred method of practicing the invention.

FIG. 2 is a schematic representation of an eye with an eye sclera.

### DESCRIPTION OF THE PREFERRED EMBODIMENTS

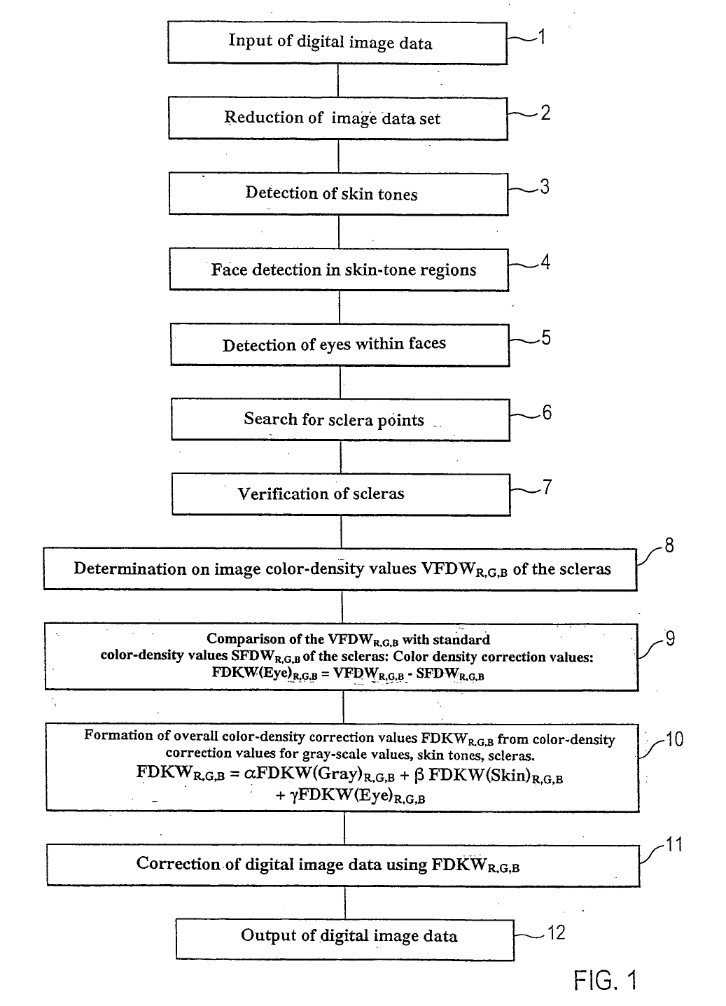

FIG. 1 is a flow chart showing the steps the method according to the invention that has the goal of configuring color and brightness levels during the reproduction of digital image data so that the intended impression or image is as close as possible to the observer's perception of reality. This image data may involve photographs, computer graphics, scanned images the like. Data input is via a scanner, a CD, or via Internet or any other digital data input. The image data set may be reduced in a Step 2 in order to save processing time and memory, since the method according to the invention may also be implemented against a reduced-resolution data set. This Step 2 is optional, however. It is equally possible to use the high-resolution data set to calculate density and color-correction values since it is more accurate. In a processing Step 3, the image data are examined for skin-tone points. The mixture ratio at which the colors red, green, and blue are present in skin tones is known from experience, and may be used to identify skin areas. It is advantageous to combine the individual, identified pixels with skin tones into specific areas. This may be achieved by seeking additional points in the vicinity of the points that are identified as skin-tone colors whose color-densities deviate less than a specified threshold value.

Faces present in the image are sought in the determined skin-tone areas in a Step 4. There exist several known face-detection procedures. Some of these procedures work with deformable grids whose grid nodes consist of distinctive facial points. Further, there exist face-detection procedures in which face templates are imposed over the skin regions and are compared for the extent of template and skin-region coincidence. One example of this procedure is disclosed in “Face Detection from Color Negative Film Using Flexible Template”, published in the

Proceedings of the IS & T/SID Eighth Color Imaging Conference, pp. 140-143. Further, there are procedures that detect faces based on geometric considerations. In principle, any known face-detection procedure may be used. It is also not absolutely necessary for the procedure based on the invention first to seek skin tones, and then to seek faces within the skin tones. It would do just as well to seek faces within each overall image. This would merely cost more computing time and require more computing capacity.

As soon as faces are detected within an image, eyes are sought within the face in a Step 5. Eye recognition may be based on proportional considerations, templates, or color considerations. A recognition method is disclosed in the U.S. Pat. No. 6,151,403, which is incorporated herein by reference. In principle, all known face-detection procedures may be used here also. Although it may take extra computing time, it is possible in principle to omit the facial detection in Step 4, and to seek eyes directly within the image data set.

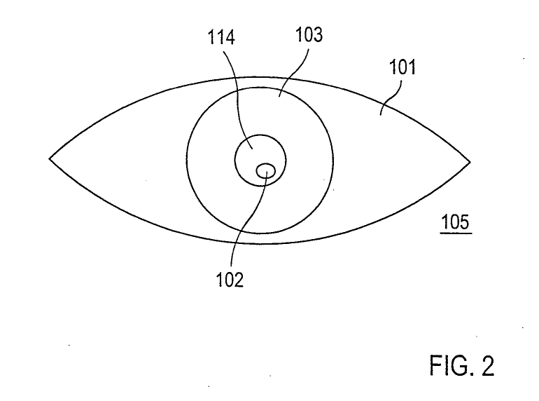

Once it is known in which area of the image the eyes are located, the scleras necessary for the invention are determined. FIG. 2, which shows a schematic view of the eye, will be used for further explanation.

In a Step 6, an area around the localized eye positions is defined in which contiguous areas of a specific size are sought that include very low color saturation. For this, the smallest color differential with respect to all colors is sought, for example, by finding the minima of R-B, R-G, or B-G. As soon as the minima of these differentials are determined, a threshold value is defined that lies not far from the minimum. Subsequently, points in the vicinity of the minimum points are sought that lie below the threshold. In this manner, a geometric formation of minimal density is determined. In a Step 7, these minimal-density areas are checked to verify that they actually represent image points of scleras 101, since photographed light reflections 102 may be involved. This verification is preferably performed based on geometric plausibility considerations. Thus, light reflections 102 are generally very small and narrow and are extended, whereas scleras 101 in general include a larger, more compact area. In order to verify scleras 101, one may equally investigate whether the region of the minimal-density areas coincide with the region of the scleras 101. Thus, this bright area, for example, must be adjacent to a circular, dark iris 103 with a pupil 114, or the opposite edge of the sclera area must be adjacent to skin tones 105. A further option to verify scleras 101 is to investigate individual colors, since with saturation of at least one color reflected light 102 is generally present instead of a sclera 101. As soon as an area is verified as belonging to sclera 101, the integral color and brightness of the sclera 101 in this area is determined in a Step 8. This determination may, for example, be via median-value formation. It is known which color-densities the sclera possesses in the image to be reproduced. In a Step 9, the determined color-density values of the image are compared with standard color-density values of scleras 101. The standard color-density values of scleras 101, used in this method, are pre-determined and stored in a buffer for this image processing. They may be determined from an optimally-reproduced sclera 101, but it is possible to derive them as a median or average value from many scleras 101 of realistically-reproduced images. One may just as well use a value that has been determined in a model study to be suitable as a standard color-density value. Any number of additional methods are also conceivable.

By means of the comparison of image color-density value with a standard color-density value, it is possible to finally obtain the color-density correction value for each of the colors red, green, and blue from the differential. In an advantageous manner, this color-density value is added to each color with the color-density correction values used for reproduction of optimal gray-scale values along with color-density correction values derived from other procedures in a Step 10. This addition of different color-density correction values into an overall color-density correction value may advantageously be performed using weighting. Depending on which image content is considered to be more important, varying weighting factors may be used in this process. Selection of the weighting factors may be performed one time for all images based on experience values, or it may be performed in dependence upon the subject of each image. A subject-dependent selection of weighting factors α, β, γ may depend, for example, on how much skin tone is contained in the image, or whether portraits or landscape scenes are involved, or how many white areas occur within the image. A wide variety of options are available to an expert. In a Step 11, the digital image data are finally corrected using the overall color-density correction values so that optimal colors and densities result in the reproduction. In a Step 12, the corrected image data are delivered.

This method according to the invention may be advantageously applied to all digital image data. It makes no difference from which source the data arrive or onto which output medium the images are to be reproduced. Light-sensitive papers that may be printed using laser beams, for example, are conceivable as a reproduction medium, as are conventional papers used in photographic laboratories. The output medium may just as well be conventional paper printed with ink. Further, projections or screen displays are conceivable as output media. The important point is that the image data be so processed that they appear to the observer of the reproduced image in accordance with his color perception.

There has thus been shown and described a novel method for automatic determination of color-density correction values which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method for the automatic determination of color-density correction values for the reproduction of digital image data, wherein image color-density values of the digital image data are at least partially determined by area and are compared with known reproduction color-density values, the improvement comprising the steps of identifying eye scleras within the image data, and determining image color-density values based on said scleras.

2. Method as recited claim 1, wherein eye positions are determined by means of a face-detection method in order to identify the scleras.

3. Method as recited in claim 1, wherein eye positions are determined by means of a “red-eye” detection method in order to identify the scleras.

4. Method as recited in claim 2, wherein areas of approximately white color are localized in the region of the eye positions in order to identify the scleras.

5. Method as recited in claim 1, wherein the identified scleras are verified based on their surrounding environment.

6. Method as recited in claim 1, wherein the identified scleras are verified based on their color saturation.

7. Method as recited in claim 1, wherein the identified scleras are verified based on their geometric characteristics.

8. Method as recited in claim 1, wherein an area is formed consisting of substantially all points belonging to a sclera.

9. Method as recited in claim 8, wherein substantially all points within the area are used to determine image color-density values of the sclera.

10. Method as recited in claim 1, wherein reproduction color-density values are determined based on statistics of color-density values from a large number of sample eye scleras.

11. Method as recited in claim 1, further comprising the steps of determining color-density correction values in dependence upon said scleras and color-density correction values in dependence upon skin tones, and adjusting the image color-density values based on said color-density correction values.
